(19) United States
(12) Patent Application Publication
(10) Pub. No.: US 2015/0131516 A1
(43) Pub. Date: May 14, 2015

(54) TRANSMISSION TIME INTERVAL EXTENSION FOR MULTIMEDIA BROADCAST MULTICAST SERVICE

(71) Applicant: QUALCOMM Incorporated, San Diego, CA (US)

(72) Inventor: Xiaoxia Zhang, San Diego, CA (US)

(21) Appl. No.: 14/532,931

(22) Filed: Nov. 4, 2014

Related U.S. Application Data
(60) Provisional application No. 61/903,325, filed on Nov. 12, 2013.

(51) Int. Cl. H04W 72/00; H04L 5/00

(52) U.S. Cl. CPC H04W 72/005; H04L 5/0016
USPC 370/312; 370/330

(57) ABSTRACT

In one embodiment, a method for performing wireless communication comprises segmenting data into multiple code blocks for encoding and transmission. A transmitter allocates the segmented blocks to a transmission time interval that encompasses frequency divided subchannels and time divided subframes. Each of the code blocks is allocated to at least one of the subchannels and to two or more of the subframes. The method further comprises transmitting the code blocks in the transmission time interval.

### CLAIM TO PRIORITY

This application claims priority to U.S. provisional application No. 61/903,325 filed on Nov. 12, 2013, which is expressly incorporated by reference herein in its entirety.

### FIELD

Aspects of the present disclosure relate generally to wireless communication systems, and more particularly, to aspects of supporting longer Transmission Time Interval (TTI) in Multimedia Broadcast Multicast Service (MBMS), Evolved MBMS (eMBMS), or analogous wireless services. More particularly the present disclosure relates to spreading each code block over a longer TTI to take advantage of the potential increased time and frequency diversity.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

The 3rd Generation Partnership Project (3GPP) Long Term Evolution (LTE) is an example of an advanced cellular technology evolved from Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. A technique for facilitating high bandwidth communication for multimedia has been single frequency network (SFN) operation. SFNs utilize radio transmitters, such as, for example, eNBs, to communicate with subscriber UEs. In unicast operation, each eNB is controlled so as to transmit signals carrying information directed to one or more particular subscriber UEs. The specificity of unicast signaling enables person-to-person services such as, for example, voice calling, text messaging, or video calling.

In broadcast operation, several eNBs in a broadcast area broadcast signals in a synchronized fashion, carrying information that can be received and accessed by any subscriber UE in the broadcast area. The generality of broadcast operation enables greater efficiency in transmitting information of general public interest, for example, event-related multimedia broadcasts. As the demand and system capability for event-related multimedia and other broadcast services has increased, system operators have shown increasing interest in making use of broadcast operation in 3GPP networks. Generally, the radio link layer is optimized for unicast operation. It may therefore desirable to optimize aspects of the radio link layer to achieve more efficient use of bandwidth for broadcast or similar transmissions.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating is a block diagram conceptually illustrating a design of a base station/eNB and a UE configured according to one aspect of the present disclosure.

FIG. 4 illustrates common allocation periods in a transmission time interval.

FIGS. 5-7 illustrate different allocation schemes for multiple code blocks in the same transmission time interval.

FIGS. 8-11 illustrate aspects of a methodology for allocating multiple code blocks within the same transmission time interval.

FIG. 12 illustrates aspects of an apparatus for allocating multiple code blocks within the same transmission time interval, in accordance with the methodologies of FIGS. 8-11.

FIGS. 13-15 illustrate aspects of a methodology for separating signals from the same transmission time interval into multiple code blocks according to a predefined allocation map, performed at a mobile entity.

FIG. 16 illustrates aspects of an apparatus for separating signals from the same transmission time interval into multiple code blocks according to a predefined allocation map, in accordance with the methodology of FIGS. 13-15.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

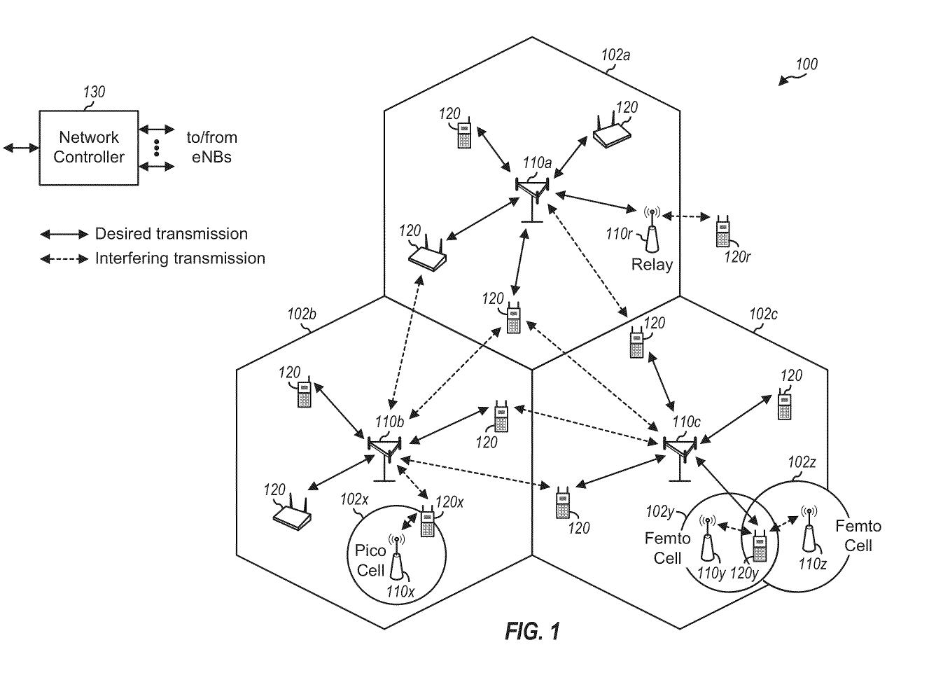

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the femto cells 102y and 102z, respectively. An eNB may support one or multiple (e.g., three) cells. The femto cells and pico cells are examples of small cells. As used herein, a small cell means a cell characterized by having a transmit power substantially less than each macro cell in the network with the small cell, for example low-power access nodes such as defined in 3GPP Technical Report (T.R.) 36.932 section 4.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 5 to 20 Watts) whereas pico eNBs, femto eNBs and relays may have a lower transmit power level (e.g., 0.1 to 2 Watts).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, a smart phone, etc. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

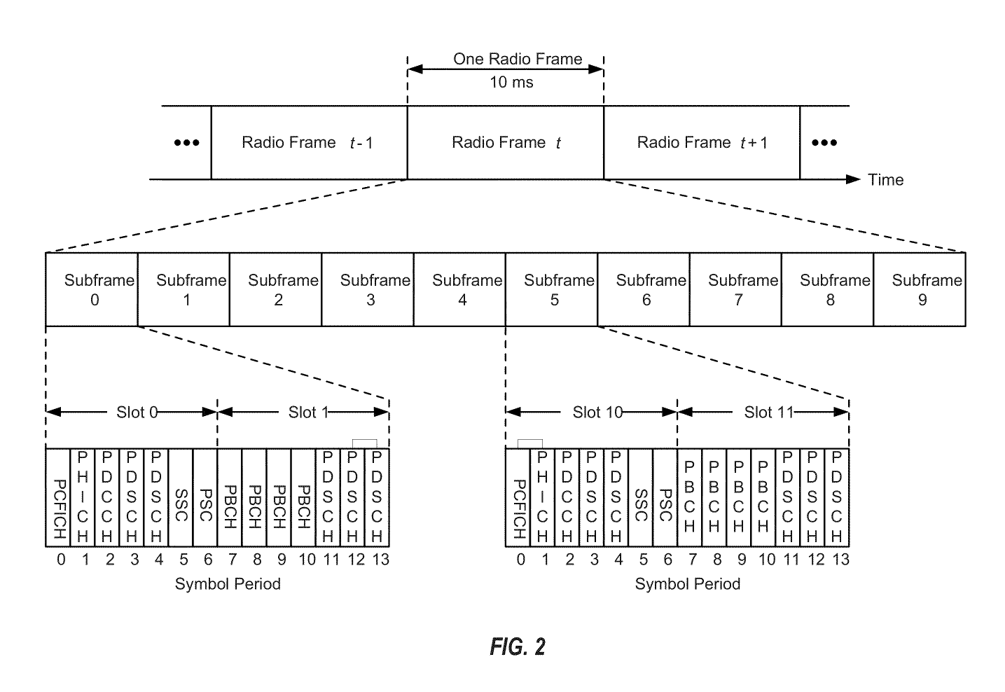

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. One or more subframes may be transmitted during a corresponding transmission time interval (TTI), representing the time required to transmit a MAC PDU. Before transmission, the transport block may be broken into multiple physical layer code blocks that are further processed at the physical layer. For example, in 3GPP LTE, the physical layer code blocks may be processed by using a turbo code, which is a parallel concatenated convolutional code wherein an information sequence is encoded by a convolutional encoder, and then an interleaved version of the information sequence is encoded by a second convolutional encoder. The LTE turbo code blocks may be limited in size, for example to 6144 bits. Code blocks are normally only visible on the physical layer.

A TTI may be defined as the period of time required to continuously transmit a MAC PDU. A MAC PDU, also referred to as a “transport block” is a set of RRC layer data that cannot be decoded by the receiver until entirely received. Each transport block is encoded by the physical layer before being transmitted on the physical channel. When the transport block size is greater than the Turbo code interleaver size, the transport block may be segmented into multiple physical layer code blocks to allow for turbo encoding before being transmitted. Generally, all the code blocks have to be successfully received to recover the MAC PDU. An extended TTI may encompass any non-zero, integer number of subframes and multiple code blocks, while consisting of a single MAC PDU. As used herein, a “code block” refers to a block of data encoded in the same turbo code at the physical layer.

For example, if the transport block size is larger than 6144 bits, it may need to be divided into multiple code blocks at the physical layer, wherein each code block is encoded separately. The UE can decode the transport block correctly only after receiving all code blocks. From the receiver point of view, the entire transport block can be decoded only when all the data transmitted during the corresponding TTI is received. However, the receiver may demodulate code blocks making up the transport block on the physical layer, before all of the code blocks have been received, depending on the allocation of code blocks within the TTI. The physical layer may distribute the code blocks within the TTI to different elements of the subframe, using various allocation schemes described later in the specification.

A radio frame may include ten subframes, wherein each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. Various channels may occupy different resource elements, which may be arranged in different symbol periods.

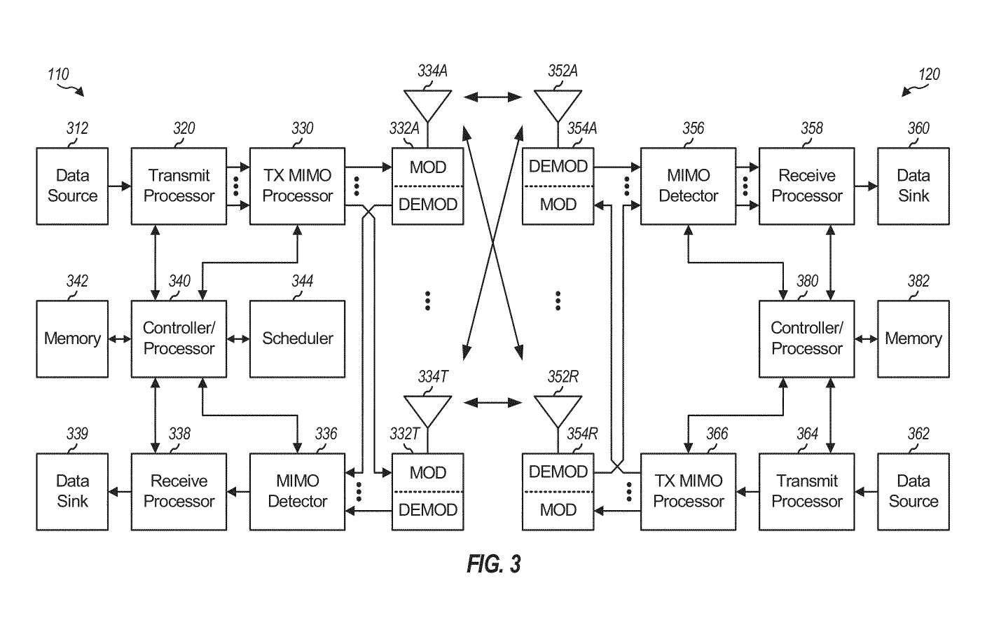

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The processor 320 may process (e.g., encode and symbol map) the data and control information to obtain data symbols and control symbols, respectively. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

In one configuration, the base station 110 may include means for means for encoding data into multiple code blocks for transmission, means for allocating the multiple code blocks to the same transmission time interval encompassing frequency-divided subchannels and time-divided subframes, according to a predefined allocation mapping scheme wherein each of the code blocks is allocated to any two or more of the subchannels and to any two or more of the subframes, and means for transmitting the code blocks in the transmission time interval. In one aspect, the aforementioned means may be, or may include, the processor(s), the controller/processor 340, the memory 342, the transmit processor 320, the TX MIMO processor 330, the modulators 334a, and the antennas 334a configured to perform the functions recited by the aforementioned means.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

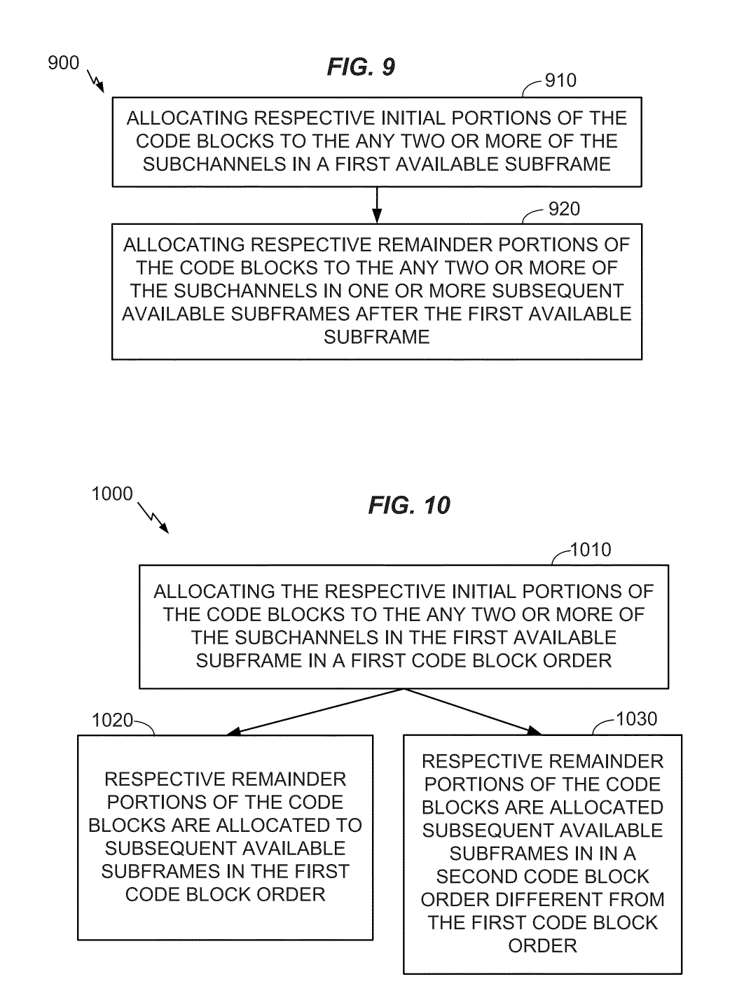

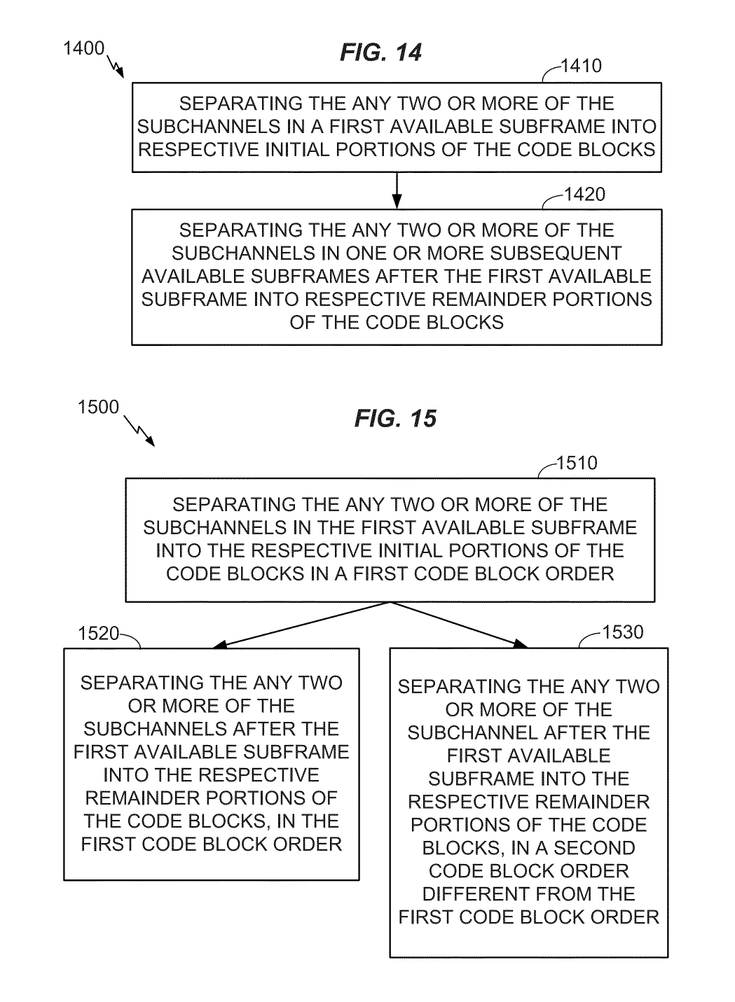

The controllers/processors 340 and 380 may direct operations of the base station 110 and the UE 120, respectively. For example, the processor 340 and/or other processors and modules at the base station 110 may perform or direct the execution of the functional blocks illustrated in FIGS. 9-12, and/or other processes for the techniques described herein. The processor 380 and/or other processors and modules at the UE 120 may also perform or direct the execution of the functional blocks illustrated in FIGS. 14-16, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for receiving radio layer signals in the same transmission time interval encompassing frequency-divided sub-channels and time-divided subframes, means for separating the signals into multiple code blocks according to a predefined allocation mapping scheme wherein each of the code blocks is allocated to any two or more of the sub-channels and to any two or more of the subframes, and means for decoding each of the code blocks thereby obtaining data. In one aspect, the aforementioned means may be, or may include, the processor(s), the controller/processor 380, the memory 382, the receive processor 358, the MIMO detector 356, the demodulators 354a, and the antennas 352a configured to perform the functions recited by the aforementioned means.

eMBMS and Unicast Signaling in Single Frequency Networks

One mechanism to facilitate high bandwidth communication for multimedia has been single frequency network (SFN) operation. Particularly, Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context, can utilize such SFN operation. SFNs utilize radio transmitters, such as, for example, eNBs, to communicate with subscriber UEs. Groups of eNBs can transmit bi-directional information in a synchronized manner, so that signals reinforce one another rather than interfere with each other. Use of eMBMS may provide an efficient way to transmit shared content from an LTE network to multiple mobile entities, such as, for example, UEs.

With respect to a physical layer (PHY) of eMBMS for LTE FDD, the channel structure may comprise time division multiplexing (TDM) resource partitioning between an eMBMS and unicast transmissions on mixed carriers, thereby allowing flexible and dynamic spectrum utilization. Currently, a subset of subframes (up to 60%), known as multimedia broadcast single frequency network (MBSFN) subframes, can be reserved for eMBMS transmission. As such current eMBMS design allows at most six out of ten subframes for eMBMS.

Extended Transmission Time Interval (TTI) in eMBMS

Consideration of longer (extended) TTI and a correspondingly larger transport block has been raised in development of new Advanced Television Systems Committee (ATSC) standards. Use of a longer TTI may provide the benefit of time diversity gain at the receiver. In time diversity, a signal is spread over time, thereby avoiding certain transmission errors from transient interference. This may result in more efficient reception of the signal or “gain” as compared to spreading the signal over a shorter interval. Time diversity gain from use of an extended TTI may be especially apparent for fixed-location receivers and lower speed receivers requiring a low Block Error Rate (BLER). For example, a rooftop wireless receiver for an ATSC or similar signal may require a much lower BLER compared to most mobile applications. Time diversity from extended TTI may be beneficial for such applications.

Conversely, use of extended TTI may include disadvantages. For example, an extended TTI may impose a corresponding increase in buffer overhead, because of the increased size of each code block that is buffered during the TTI, prior to encoding at the transmission side, and prior to decoding at the reception side. The extended TTI may similarly cause a corresponding increase in latency. However, in some applications such as receiving video content using an ATSC or similar standard, or via eMBMS, these disadvantages may be outweighed by the opportunity to achieve time diversity gain afforded by extended TTI. Implementing extended TTI in eMBMS may entail various challenges. Design goals of a longer TTI implementation in eMBMS may include increasing time diversity gain while reducing signaling overhead/change as compared to current eMBMS.

Multicasts within a MBSFN area may include downlink-only services provided on corresponding multicast channels (MCHs). Every MCH defined for a particular MBSFN area may be transmitted in a defined pattern of MBSFN subframes called the Common Subframe Allocation (CSFA) period, sometimes abbreviated as “commonsf-AllocPeriod.” CSFA periods may be organized in a repeating time sequence, wherein each CSFA period includes the same MCHs in the same pattern of MBSFN subframes. Currently, CSFA periods may range in duration from 40 to 2560 ms, for example, 40, 80, 160, 320, 640, 1280 or 2560 ms, although the present technology is not limited to this range or to these specific values.

A TTI may be extended to encompass one CSFA period, or multiple CSFA periods. Within each CSFA period, a list or other definition of the MBSFN subframes allocated to a particular service may be provided by MCH Scheduling Information (MSI) transmitted in a Media Access Control (MAC) layer element. Likewise, within each CSFA period a list or other definition of which MBSFN subframes are allocated to each Physical Multicast Channel (PMCH) may be transmitted in a Multicast Control Channel (MCCH). The MSI and MCCH should remain constant across multiple CSFA periods within a TTI.

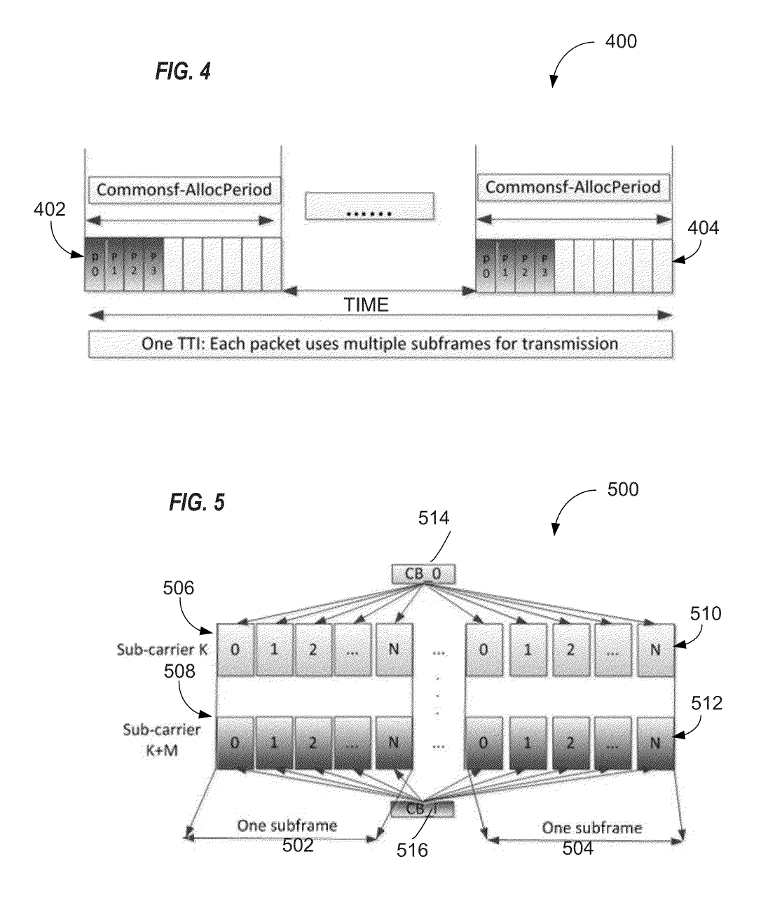

In an aspect, an extended TTI in eMBMS may enable transmitting a higher-layer code block (e.g., an MBSFN data packet) over multiple CSFA periods, to provide the benefit of time diversity. That is, in the eMBMS signaling context, an extended TTI may entail the use of multiple CSFA periods. FIG. 4 illustrates the concept of a TTI 100 including various different CSFA periods 402, 404 (two of many shown). Each of the MBSFN code blocks P0, P1, P2, etc., is transmitted in subframes belonging to different CSFA periods, for example to both of the illustrated CSFA periods 402, 404. In another example, an extended TTI in eMBMS may enable transmitting a higher-layer code block (e.g., an MBSFN data packet) over multiple MBSFN subframes within a single CSFA period, to provide the benefit of time diversity. That is, in the eMBMS signaling context, an extended TTI may entail the use of multiple MBSFN subframes within a single CSFA period.

For high signal-to-noise ratio (SNR) applications such as roof-top receivers, an extended TTI and commensurately large MAC PDUs may be beneficial. Accordingly, each transport block may be broken down into multiple code blocks transmitted during a corresponding TTI and symbols from each code block allocated to different CSFA periods. Transmission of multiple code blocks within a single TTI is also more likely with extended TTI in eMBMS or the like. In circumstances where multiple code blocks are included in a single TTI, the receiver may not benefit from the potential time diversity gain that extending the TTI should bring. While the greater time diversity may be associated with an extended TTI, this time diversity does not necessarily extend to the individual code blocks and when the code blocks cannot benefit from extended time diversity, the transport block cannot benefit either as the successful reception of transport block requires successful reception of each individual code blocks. Time diversity may be thwarted for code blocks when each of the code blocks is allocated to a single contiguous portion of the TTI, for example, to a single subframe, as occurs in conventional sequential allocation in frequency. Under conventional allocation schemes, the code blocks may not be able to exploit the potential time diversity associated with the use of an extended TTI.

A longer TTI may also be advantageous when transmitting eMBMS services over LTE—Unlicensed spectrum. WiFi interference can change dynamically from one subframe to the next and a longer TTI can reduce the SNR variation within the TTI. A reduced SNR variation within the TTI can be beneficial for eMBMS by allowing a better data rate. The eMBMS transmission is typically received by multiple UEs and eMBMS data rate generally is dictated by the worst UE SNR within the target coverage area. A longer TTI can result in a smaller variation in SNR which translates into a higher data rate. In such scenario, the TTI is preferred to encompass subframes subject to different WiFi interference levels. For example, when LBT (listen before talk) protocol is used for LTE-unlicensed spectrum, the TTI is preferred to span over multiple LBT frames to allow for interference variation.

To overcome the problem of lower-layer time diversity thwarting, a transmitter may use an allocation method that employs a mapping scheme designed to allocate bits of each code block to resource elements of the allocated MBSFN subframes in a pattern that time-spreads the code block within the TTI. In one MBSFN application, TTI duration may be configured as an integer multiple of the MBSFN subframes. In other MBSFN applications, TTI duration may be configured as an integer multiple of the CSFA period. When TTI duration is configured as an integer multiple of the CSFA period, within a TTI, the same MSI and MCCH may be maintained for each CSFA period to minimize signaling overhead.

Various different time-spreading mappings are described below, as examples for MBSFN, fixed-receiver, or other applications. The present technology is not limited to these examples.

In a first example, a transmitter may use a time-first mapping scheme for downlink resource allocation that resembles aspects of uplink resource allocation in LTE. FIG. 5 illustrates a TTI 500 including multiple subframes 502, 504 (two of many shown) and corresponding resource element groups 506, 508, 510, 512 (four of many shown) each comprised of “N” number of resource elements in a specific subcarrier frequency and subframe. The horizontal direction represents time and the vertical direction represents frequency. In a time-first allocation scheme, each code block is first allocated across time within a single frequency subcarrier, before being allocated to a different subcarrier. For example, a first code block 514 may be allocated so as to fill a continuous time sequence of resource elements 506, 510 in a first subcarrier ‘K’ while a second code block 516 is allocated so as to fill a continuous time sequence of resource elements 508, 512 in a second subcarrier ‘K+M’. Under this mapping scheme, each code block 514, 516 can be provided with some or all of the time diversity enabled by the extended TTI 500, depending on the degree of time spreading accomplished by the mapping scheme. However, frequency diversity is reduced or eliminated for individual code blocks.

Alternatively, a time-first mapping scheme can also be used to allocate a code block within a single frequency carrier and a single subframe, i.e., within a single resource element group. Such an implementation can provide the benefit of time diversity without extending the TTI. For example, a first code block may be allocated so as to fill a continuous time sequence of symbols or resource elements within a particular subframe and a particular subcarrier. Referring to FIG. 5, code block 514 may be allocated so as to fill resource element group 506 and not make use of resource element group 510. Similarly, code block 516 may be allocated so as to fill resource element group 508 and not make use of resource element group 512. Thus, the granularity for allocating code blocks can be in terms of symbols or individual resource elements rather than the multiple subframes that can be used when extending the TTI.

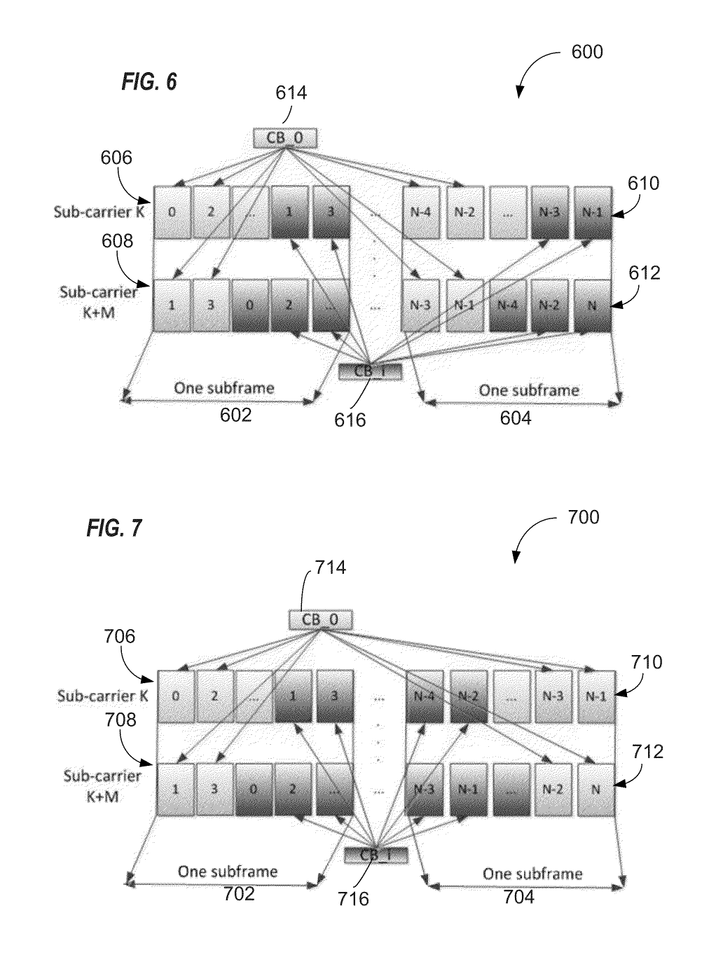

In a second example, a transmitter may use an interleaved time-frequency mapping scheme for downlink resource allocation, as shown in FIG. 6 for a TTI 600. The TTI 600 includes multiple subframes 602, 604 (two of many shown) and corresponding resource element groups 606, 608, 610, 612 (four of many shown) each comprised of “N” number of resource elements in a specific subcarrier frequency and subframe. The horizontal direction represents time and the vertical direction represents frequency. In an interleaved time-frequency allocation scheme, the transmitter allocates each code block 614, 616 across a time-frequency grid including specific resource elements in each subcarrier frequency and subframe. For example, each code block can be divided into multiple parts where each part may be allocated to each subframe based on first on subcarrier frequency and the different parts can span multiple subframes within a TTI. The subframe duration depends on CP length and may be, for example, 1 ms, 2 ms, or some other value. This approach may provide both time and frequency diversity for each code block. FIG. 6 shows an allocation scheme wherein the allocation order of the code blocks is the same in each subframe, for example the first code block 614 is allocated to an initial part of OFDM symbols in each subframe 602, 604, and the second code block is allocated to the last part of OFDM symbols in each subframe.

In another aspect, as shown in FIG. 7 for a TTI 700, a transmitter may vary the order in which each code block 714, 716 is allocated across time, from one subframe 702 to the next subframe 704. In FIG. 7, the horizontal direction represents time and the vertical direction represents frequency. In addition, the transmitter may allocate a portion of each of the code blocks to a different subcarrier frequency, as described in connection with FIG. 6, to provide both time and frequency diversity. The resource element groups 706, 708, 710, and 712 (four of many shown) may each include “N” number of resource elements in a specific subcarrier frequency and subframe. Because of the variation in order, for example, the first code block 714 may be allocated to the initial part of OFDM symbols in subframe 702 and to the last part of subframe 704, while the second code block may be allocated to the last part of subframe 702 and to the first part of subframe 704. In an aspect, a transmitter may vary the order in which code blocks are allocated from one subframe to another, for example to achieve better interference diversity. Variations in allocation order may be linked to each subframe within a TTI according to a predetermined scheme, or may be signaled (e.g., via MSI or MCCH) within a TTI. For example, the order pattern of code blocks within a particular subframe can be derived using a bit reversal interleaver, or a predefined rule that both the eNB and UE have a record of and implement to spread and recover code blocks, respectively.

### Example Methodologies and Apparatus

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored as encoded instructions and/or data on an article of manufacture to facilitate transporting and transferring such methodologies to various devices. Those skilled in the art will understand and appreciate that a method could alternatively be represented as a series of interrelated states or events, such as in a state diagram.

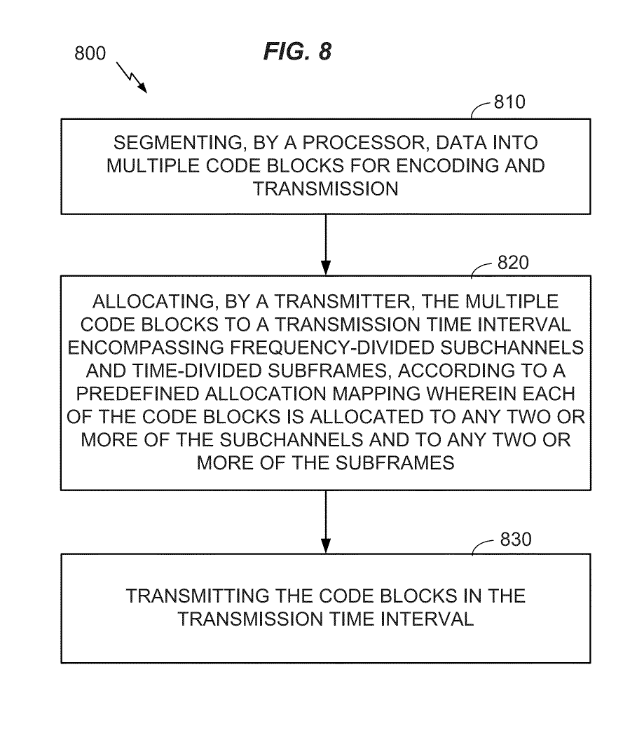

FIG. 8 shows a method 800 by a base station for wireless communication, including transmitting a signal using an extended TTI including multiple code blocks allocated to increase time diversity, and optionally frequency diversity, for each code block. The base station may be a base station (e.g., eNB, femto node, pico node, Home Node B, etc.) of a wireless communications network. The method 800 may include, at 810, segmenting, by a processor, data into multiple code blocks for encoding and transmitting in a single TTI of a radio layer. Accordingly, the data may represent a single MAC PDU (transport block) at the RRC layer, which is broken into multiple code blocks which may be turbo encoded for transmission.

The method 800 may include, at 820, allocating, by a transmitter, the multiple code blocks to a transmission time interval encompassing frequency-divided subchannels and time-divided subframes, according to a predefined allocation mapping wherein each of the code blocks is allocated to any two or more of the subchannels and to any two or more of the subframes. The multiple code blocks are allocated to a common (the same) transmission time interval. More detailed aspects of allocating the multiple code blocks are discussed above in connection with FIGS. 5-7, and below in connection with FIGS. 9-11. The method 800 may include, at 830, transmitting the code blocks in the transmission time interval.

FIGS. 9-11 show further optional operations or aspects 900, 1000, 1100 that may be performed by the base station in conjunction with the method 800. The operations shown in FIGS. 9-11 are not required to perform the method 800. Operations 900, 1000, 1100 are independently performed and not mutually exclusive. Therefore any one of such operations may be performed regardless of whether another downstream or upstream operation is performed. If the method 800 includes at least one operation of FIGS. 9-11, then the method 800 may terminate after the at least one operation, without necessarily having to include any subsequent downstream operation(s) that may be illustrated.

Referring to FIG. 9, the allocating operation 820 of the method 800 may further include, at 910, allocating respective initial portions of the code blocks to the any two or more of the subchannels in a first available subframe. In addition, the allocating 820 may include, at 920, allocating respective remainder portions of the code blocks to the any two or more of the subchannels in one or more subsequent available subframes after the first available subframe. Further aspects of the allocating operations 910 and 920 may be as described above in connection with FIGS. 6-7.

Operations related to interleaved time-frequency allocation for an extended TTI are described with reference to FIG. 10. In an aspect, the allocating operation 820 of the method 800 may further include, at 1010, allocating the respective initial portions of the code blocks to the any two or more of the subchannels in the first available subframe in a first code block order. For example, assuming there are four code blocks 0, 1, 2, and 3 with two subframes within a TTI, the first code block order could be sequential starting from zero (0,1,2,3). In a first alternative, illustrated at 1020, the transmitter may allocate respective remainder portions of the code blocks to the any two or more of the subchannels in one or more subsequent available subframes after the first available subframe, in the first code block order. Aspects of this alternative may be as described above in connection with FIG. 6.

In a second alternative, illustrated at 1030, the transmitter may allocate respective remainder portions of the code blocks to the any two or more of the subchannels in one or more subsequent available subframes after the first available subframe, in a second code block order different from the first code block order. In the previous example, the second code block order could be (3, 2, 1, 0) or could be (3, 1, 2, 0). Other aspects of this alternative may be as described above in connection with FIG. 7.

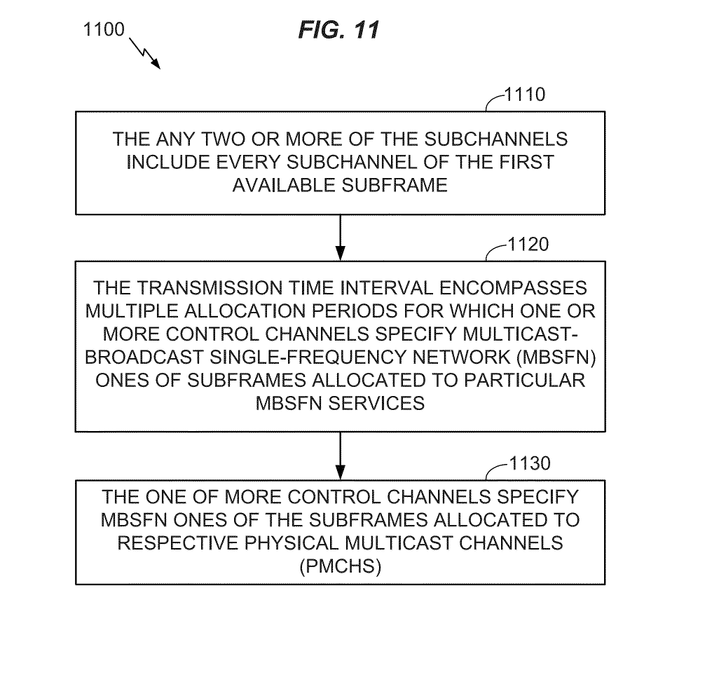

The method 800 may further include the operations or aspects 1100 as shown in FIG. 11. In an aspect, as illustrated at 1110, the any two or more of the subchannels to which the code blocks are allocated include every subchannel of the first available subframe. In another aspect pertinent to MBSFN operations, the TTI encompasses multiple allocation periods for which one or more control channels specify MBSFN ones of subframes allocated to particular MBSFN services, as illustrated at 1120. In addition, or in the alternative, the one of more control channels may further specify MBSFN ones of the subframes allocated to respective Physical Multicast Channels (PMCHs), as illustrated at 1130.

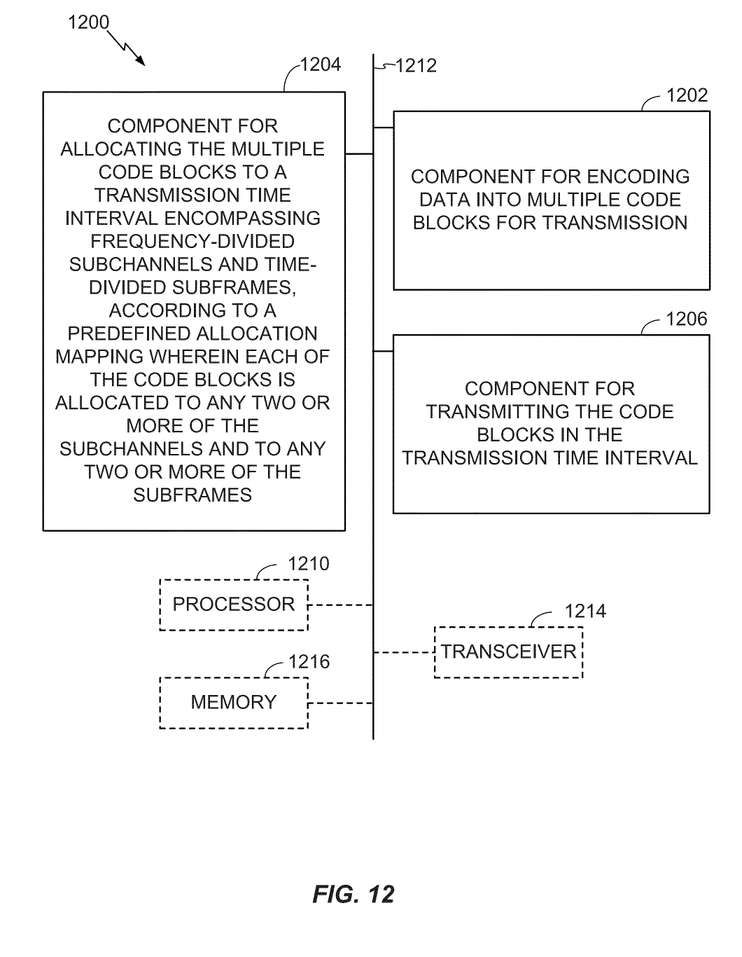

With reference to FIG. 12, there is provided an exemplary apparatus 1200 that may be configured as a base station in a wireless network, or as a processor or similar device for use within the base station, for transmitting a transport block using an extended TTI for eMBMS or other applications. The apparatus 1200 may include functional blocks that can represent functions implemented by a processor, software, hardware, or combination thereof (e.g., firmware).

As illustrated, in one embodiment, the apparatus 1200 may include an electrical component or module 1202 for segmenting data into multiple code blocks for encoding and transmission. For example, the electrical component 1202 may include at least one control processor coupled to a transceiver or the like and to a memory with instructions for encoding an MBSFN data packet. The component 1202 may be, or may include, a means for segmenting data into multiple code blocks for encoding and transmission. Said means may include the control processor executing an algorithm for segmenting data and encoding the data in a packet to obtain data symbols (e.g., OFDM symbols) for providing to a physical layer.

The apparatus 1200 may include an electrical component 1204 for allocating the multiple code blocks to a transmission time interval encompassing frequency-divided subchannels and time-divided subframes, according to a predefined allocation mapping wherein each of the code blocks is allocated to any two or more of the subchannels and to any two or more of the subframes. The multiple code blocks may be allocated to a common (i.e., to the same) transmission time interval. An allocation mapping scheme may be, for example, as illustrated in FIGS. 6 and 9 or FIGS. 7 and 10. For example, the electrical component 1204 may include at least one control processor coupled to a transceiver or the like and to a memory holding instructions for performing the allocation. The component 1204 may be, or may include, a means for allocating the multiple code blocks to a transmission time interval encompassing frequency-divided subchannels and time-divided subframes, according to a predefined allocation mapping wherein each of the code blocks is allocated to any two or more of the subchannels and to any two or more of the subframes. Said means may include the control processor executing an algorithm as described in connection with FIG. 9 or 10.

The apparatus 1200 may include an electrical component 1206 for transmitting the code blocks in the transmission time interval. For example, the electrical component 1206 may include at least one control processor coupled to a transceiver or the like and to a memory holding instructions for transmitting data in a radio link layer. The component 1206 may be, or may include, a means for transmitting the code blocks in the transmission time interval. Said means may include the control processor executing an algorithm including processing an output symbol stream (e.g., for OFDM, etc.) to obtain an output sample stream, further processing (e.g., converting to analog, amplifying, filtering, and upconverting) the output sample stream to obtain a downlink signal, and transmitting the downlink signal via the antennas.

The apparatus 1200 may include similar electrical components for performing any or all of the additional operations 900-1100 described in connection with FIGS. 9-11, which for illustrative simplicity are not shown in FIG. 12.

In related aspects, the apparatus 1200 may optionally include a processor component 1210 having at least one processor, in the case of the apparatus 1200 configured as a network entity. The processor 1210, in such case, may be in operative communication with the components 1202-1206 or similar components via a bus 1212 or similar communication coupling. The processor 1210 may effect initiation and scheduling of the processes or functions performed by electrical components 1202-1206. The processor 1210 may encompass the components 1202-1206, in whole or in part. In the alternative, the processor 1210 may be separate from the components 1202-1206, which may include one or more separate processors.

In further related aspects, the apparatus 1200 may include a radio transceiver component 1214. A standalone receiver and/or standalone transmitter may be used in lieu of or in conjunction with the transceiver 1214. In the alternative, or in addition, the apparatus 1200 may include multiple transceivers or transmitter/receiver pairs, which may be used to transmit and receive on different carriers. The apparatus 1200 may optionally include a component for storing information, such as, for example, a memory device/component 1216. The computer readable medium or the memory component 1216 may be operatively coupled to the other components of the apparatus 1200 via the bus 1212 or the like. The memory component 1216 may be adapted to store computer readable instructions and data for performing the activity of the components 1202-1206, and subcomponents thereof, or the processor 1210, the additional aspects 900-1100, or the methods disclosed herein. The memory component 1216 may retain instructions for executing functions associated with the components 1202-1206. While shown as being external to the memory 1216, it is to be understood that the components 1202-1206 can exist within the memory 1216.

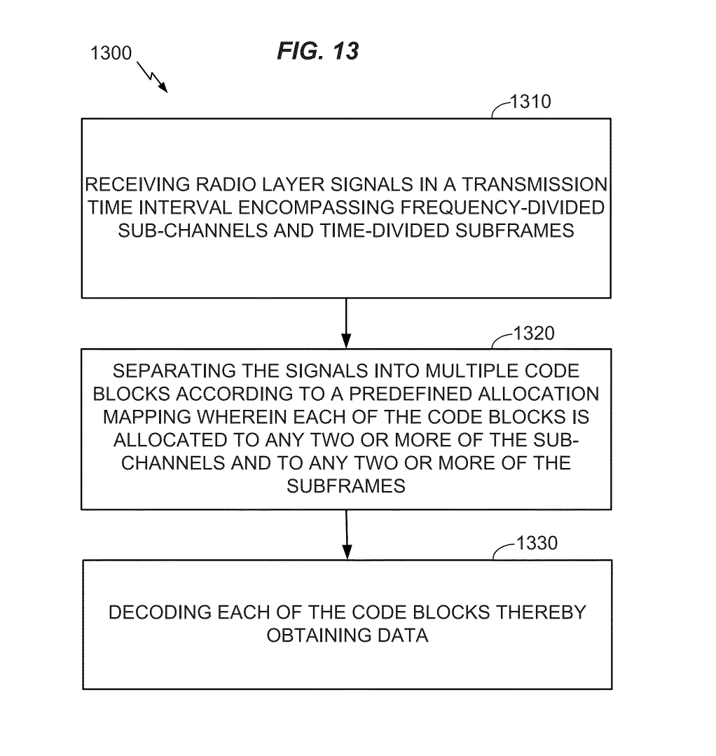

In other aspects, a mobile entity (e.g., a UE) or other receiver of a wireless communication network may perform a method 1300 for receiving a signal with multiple time and frequency spread code blocks in an extended TTI, as shown in FIG. 13. The method 1300 may include, at 1310, receiving, receiving radio layer signals in a transmission time interval encompassing frequency-divided sub-channels and time-divided subframes. The transmission time interval may comprise a single extended TTI including multiple code blocks, and the receiver may recover symbols received during the TTI. The method 1300 may further include, at 1320, the receiver separating the signals into multiple code blocks according to a predefined allocation mapping indicating how each of the code blocks was allocated to any two or more of the sub-channels and to any two or more of the subframes when transmitted. The receiver may reassemble one or more code blocks based on a code block to resource element mapping, wherein each subframe in the TTI may have a common mapping or may have different mappings. Further aspects of the allocation mapping schemes may be as described in connection with FIGS. 6-7. Separation of the signals may be a logically converse operation of the code block allocation performed by the transmitter. The method 1300 may further include, at 1330, decoding each of the code blocks thereby obtaining data, for example thereby recovering a transport block. The operation 1330 (decoding) may be initiated upon reception of a first code block of the TTI. The transport block cannot be recovered until all the code blocks in the TTI have been decoded.

Accordingly, the speed with which the transport block may be recovered may depend on the type of mapping used to allocate symbols of a code block to resource elements in a TTI. For example, a longer decode time may be required when each code block is spread across the TTI, because no entire code block is received until the TTI has elapsed. In comparison, if the mapping allocates each code block to a relatively small temporal portion of the TTI, the receiver may decode some of the code blocks while still receiving later code blocks in the same TTI. For example, a receiver may combine a portion of code block 0 in subframe 1 with the portion of code block 0 in subframe 2, and so forth, based on the mapping known to both the transmitter and receiver. For further example, given 4 code blocks (0-3) allocated to 2 subframes, subframe 1 may be allocated a portion of code block 0, a portion of code block 1, a portion of code block 2, and a portion of code block 3; while subframe 2 may be allocated a portion of code block 3, a portion of code block 1, portion of code block 2, and portion of code block 0. In this example, the receiver recovers a first portion of code block 0 from subframe 1 and a second portion of code block 0 from subframe 2, to reassemble and then decode code block 0.

FIGS. 14-15 show further optional operations or aspects 1400 and 1500 that may be performed by the base station in conjunction with the method 1300. The operations shown in FIGS. 14-15 are not required to perform the method 1300. Operations 1400 and 1500 are independently performed and not mutually exclusive. Therefore any one of such operations may be performed regardless of whether another downstream or upstream operation is performed. If the method 1300 includes at least one operation of FIGS. 14-15, then the method 1300 may terminate after the at least one operation, without necessarily having to include any subsequent downstream operation(s) that may be illustrated.

Referring to FIG. 14, the separating operation 1320 of the method 1300 may further include, at 1410, separating the any two or more of the subchannels in a first available subframe into respective initial portions of the code blocks. In addition, the separating 1320 may include, at 1420, separating the any two or more of the subchannels in one or more subsequent available subframes after the first available subframe into respective remainder portions of the code blocks. Further aspects of the separating operations 1410 and 1420 may be consistent with the allocation mapping described above in connection with FIGS. 6-7, wherein separation is the converse of allocation.

Further aspects of separating code blocks from an interleaved time-frequency allocation in an extended TTI are described with reference to FIG. 15. In an aspect, the separating operation 1320 of the method 1300 may further include, at 1510, separating the any two or more of the subchannels in the first available subframe into the respective initial portions of the code blocks in a first code block order. In a first alternative, illustrated at 1520, the receiver may separate the any two or more of the subchannels after the first available subframe into the respective remainder portions of the code blocks, in the first code block order. Aspects of this alternative may be as described above in connection with FIG. 6, wherein separating in the converse of allocating.

In a second alternative, illustrated at 1530, the receiver may separate the any two or more of the subchannel after the first available subframe into the respective remainder portions of the code blocks, in a second code block order different from the first code block order. Other aspects of this alternative may be as described above in connection with FIG. 7.

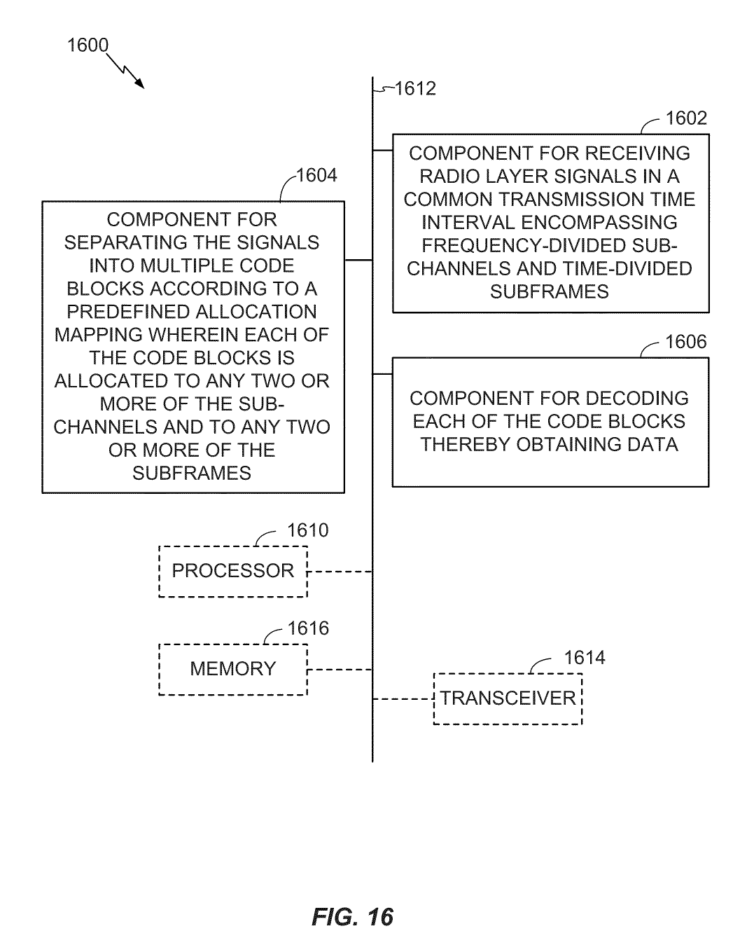

With reference to FIG. 16, there is provided an exemplary apparatus 1600 that may be configured as a mobile entity in a wireless network or other receiver, or as a processor or similar device for use within receiver, for separating multiple code blocks transmitted in an extended TTI. The apparatus 1600 may include functional blocks that can represent functions implemented by a processor, software, or combination thereof (e.g., firmware).

As illustrated, in one embodiment, the apparatus 1600 may include an electrical component or module 1602 for receiving radio layer signals in a transmission time interval encompassing frequency-divided sub-channels and time-divided subframes. For example, the electrical component 1602 may include at least one control processor coupled to a transceiver or the like and to a memory with instructions for receiving data in a radio link layer. The component 1602 may be, or may include, a means for receiving radio layer signals in a transmission time interval encompassing frequency-divided sub-channels and time-divided subframes. Said means may include the control processor executing an algorithm for receiving a downlink signal via one or more antennas, processing the downlink signal to obtain an output sample stream, and further processing the output sample stream (e.g., converting to digital) to obtain an output symbol stream (e.g., OFDM or other modulation scheme).

The apparatus 1600 may include an electrical component 1604 for separating the signals into multiple code blocks according to a predefined allocation mapping wherein each of the code blocks is allocated to any two or more of the sub-channels and to any two or more of the subframes. For example, the electrical component 1604 may include at least one control processor coupled to a transceiver or the like and to a memory holding instructions for separating the signals. The component 1604 may be, or may include, a means for separating the signals into multiple code blocks according to a predefined allocation mapping wherein each of the code blocks is allocated to any two or more of the sub-channels and to any two or more of the subframes. Said means may include the control processor executing an algorithm for separating the symbols into code blocks by a converse operation to the allocation schemes described above in connection with FIGS. 6-7.

The apparatus 1600 may include an electrical component 1606 for decoding each of the code blocks thereby obtaining data. For example, the electrical component 1606 may include at least one control processor coupled to a transceiver or the like and to a memory holding instructions for decoding the code blocks or packets using a designated decoding method. The component 1606 may be, or may include, a means for decoding each of the code blocks thereby obtaining data. Said means may include the control processor reading the encoded symbols and applying any suitable decoding operation based on an assumed or detected coding scheme.

In related aspects, the apparatus 1600 may optionally include a processor component 1610 having at least one processor, in the case of the apparatus 1600 configured as a mobile entity. The processor 1610, in such case, may be in operative communication with the components 1602-1606 or similar components via a bus 1612 or similar communication coupling. The processor 1610 may effect initiation and scheduling of the processes or functions performed by electrical components 1602-1606. The processor 1610 may encompass the components 1602-1606, in whole or in part. In the alternative, the processor 1610 may be separate from the components 1602-1606, which may include one or more separate processors.

In further related aspects, the apparatus 1600 may include a radio transceiver component 1614. A standalone receiver and/or standalone transmitter may be used in lieu of or in conjunction with the transceiver 1614. In the alternative, or in addition, the apparatus 1600 may include multiple transceivers or transmitter/receiver pairs, which may be used to transmit and receive on different carriers. The apparatus 1600 may optionally include a component for storing information, such as, for example, a memory device/component 1616. The computer readable medium or the memory component 1616 may be operatively coupled to the other components of the apparatus 1600 via the bus 1612 or the like. The memory component 1616 may be adapted to store computer readable instructions and data for performing the activity of the components 1602-1606, and subcomponents thereof, or the processor 1610, or the methods disclosed herein. The memory component 1616 may retain instructions for executing functions associated with the components 1602-1606. While shown as being external to the memory 1616, it is to be understood that the components 1602-1606 can exist within the memory 1616.

Further or more detailed aspects of the present disclosure may be provided in the attached Appendix.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and Blu-ray™ disc where disks usually encode data magnetically, while “discs” customarily refer to media encoded optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and features disclosed herein.

What is claimed is:

1. A method for wireless communication, comprising:
segmenting, by a processor, data into multiple code blocks for encoding and transmission;
allocating, by a transmitter, the multiple code blocks to a transmission time interval encompassing frequency-divided subchannels and time-divided subframes, according to a predefined allocation mapping wherein each of the code blocks is allocated to at least one of the subchannels and to at least two of the subframes; and
transmitting the code blocks in the transmission time interval.

2. The method of claim 1, wherein the allocating comprises allocating respective initial portions of the code blocks to the at least one of the subchannels in a first available subframe.

3. The method of claim 2, wherein the allocating further comprises allocating respective remainder portions of the code blocks to the at least one of the subchannels in one or more subsequent available subframes after the first available subframe.

4. The method of claim 2, wherein the respective initial portions of the code blocks are allocated to the at least one of the subchannels in the first available subframe in a first code block order.

5. The method of claim 4, wherein the allocating further comprises allocating respective remainder portions of the code blocks to the at least one of the subchannels in one or more subsequent available subframes after the first available subframe, in the first code block order.

6. The method of claim 4, wherein the allocating further comprises allocating respective remainder portions of the code blocks to the at least one of the subchannels in one or more subsequent available subframes after the first available subframe, in a second code block order different from the first code block order.

7. The method of claim 2, wherein the at least one of the subchannels comprises every subchannel of the first available subframe.

8. The method of claim 1, wherein the transmission time interval encompasses multiple allocation periods for which one or more control channels specify Multicast-Broadcast Single-Frequency Network (MBSFN) ones of subframes allocated to particular MBSFN services.

9. The method of claim 8, wherein the one of more control channels further specify MBSFN ones of the subframes allocated to respective Physical Multicast Channels (PMCHs).

10. An apparatus for wireless communication, comprising:
at least one processor configured for:
segmenting data into multiple code blocks for encoding and transmission,
allocating the multiple code blocks to a transmission time interval encompassing frequency-divided subchannels and time-divided subframes, according to a predefined allocation mapping wherein each of the code blocks is allocated to at least one of the subchannels and to at least two of the subframes, and
transmitting the code blocks in the transmission time interval; and
a memory coupled to the at least one processor for storing data.

11. The apparatus of claim 10, wherein the at least one processor performs the allocating by allocating respective initial portions of the code blocks to the at least one of the subchannels in a first available subframe.

12. The apparatus of claim 11, wherein the at least one processor performs the allocating by allocating respective remainder portions of the code blocks to the at least one of the subchannels in one or more subsequent available subframes after the first available subframe.

13. The apparatus of claim 11, wherein the at least one processor allocates the respective initial portions of the code blocks to the at least one of the subchannels in the first available subframe in a first code block order.

14. The apparatus of claim 13, wherein the at least one processor allocates respective remainder portions of the code blocks to the at least one of the subchannels in one or more subsequent available subframes after the first available subframe, in the first code block order.

15. The apparatus of claim 13, wherein the at least one processor allocates respective remainder portions of the code blocks to the at least one of the subchannels in one or more subsequent available subframes after the first available subframe, in a second code block order different from the first code block order.

16. A method for wireless communication, comprising:
receiving radio layer signals in a transmission time interval encompassing frequency-divided sub-channels and time-divided subframes;
separating, by a receiver, the signals into multiple code blocks according to a predefined allocation mapping wherein each of the code blocks is allocated to at least one of the sub-channels and to at least two of the subframes; and
decoding, by a processor, each of the code blocks thereby obtaining data.

17. The method of claim 16, wherein the separating comprises separating the at least one of the subchannels in a first available subframe into respective initial portions of the code blocks.

18. The method of claim 17, wherein the separating comprises separating the at least one of the subchannels in one or more subsequent available subframes after the first available subframe into respective remainder portions of the code blocks.

19. The method of claim 17, wherein the at least one of the subchannels in the first available subframe is separated into the respective initial portions of the code blocks in a first code block order.

20. The method of claim 18, wherein the separating comprises separating the at least one of the subchannels in one or more subsequent available subframes after the first available subframe into the respective remainder portions of the code blocks, in the first code block order.

21. The method of claim 18, wherein the separating comprises separating the at least one of the subchannels in one or more subsequent available subframes after the first available subframe the respective remainder portions of the code blocks, in a second code block order different from the first code block order.

22. The method of claim 16, wherein the at least one of the subchannels comprises every subchannel of the first available subframe.

23. The method of claim 16, wherein the transmission time interval encompasses multiple allocation periods for which one or more control channels specify Multicast-Broadcast Single-Frequency Network (MBSFN) ones of subframes allocated to particular MBSFN services.

24. The method of claim 23, wherein the one of more control channels further specify MBSFN ones of the subframes allocated to respective Physical Multicast Channels (PMCHs).

25. An apparatus for wireless communication, comprising:
at least one processor configured for:
receiving radio layer signals in a transmission time interval encompassing frequency-divided sub-channels and time-divided subframes,
separating the signals into multiple code blocks according to a predefined allocation mapping wherein each of the code blocks is allocated to at least one of the sub-channels and to at least two of the subframes, and
decoding each of the code blocks thereby obtaining data; and
a memory coupled to the at least one processor for storing data.

26. The apparatus of claim 25, wherein the processor is further configured for separating the at least one of the subchannels in a first available subframe into respective initial portions of the code blocks.

27. The apparatus of claim 26, wherein the processor is further configured for separating the at least one of the subchannels in one or more subsequent available subframes after the first available subframe into respective remainder portions of the code blocks.

28. The apparatus of claim 26, wherein the processor is further configured for separating the at least one of the subchannels in the first available subframe into the respective initial portions of the code blocks in a first code block order.

29. The apparatus of claim 27, wherein the processor is further configured for separating the at least one of the subchannels in one or more subsequent available subframes after the first available subframe respective into the respective remainder portions of the code blocks, in the first code block order.

30. The apparatus of claim 27, wherein the processor is further configured for separating the at least one of the subchannels in one or more subsequent available subframes after the first available subframe the respective remainder portions of the code blocks, in a second code block order different from the first code block order.
